(19) United States
(12) Patent Application Publication
(10) Pub. No.: US 2012/0235373 A1
(43) Pub. Date: Sep. 20, 2012

(54) METHOD AND APPARATUS FOR STEERING A DOUBLE-PIVOT STEERING SYSTEM OF A MOTOR VEHICLE

(76) Inventors: Ralf Hintzen, Aachen (DE); Thomas Gerhards, Niederzier (DE); Friedrich Peter Wolf-Monheim, Aachen (DE); Paul Zandbergen, Montzen (BE)

(21) Appl. No.: 13/421,054

(22) Filed: Mar. 15, 2012

(30) Foreign Application Priority Data
Mar. 16, 2011 (DE) 102011005611.4

(51) Int. Cl. B62D 7/09

(52) U.S. Cl. 280/93.506

(57) ABSTRACT

A method and apparatus for steering wheels of at least one vehicle axle with a double-pivot steering system having a load adjusting device associated with the wheels and using the load adjusting device to modify a contact force of a wheel on the vehicle axle, during cornering, to adopt an angle of steering lock for a wheel on an outside bend that is larger than an angle of steering lock for a wheel on an inside bend.

### CROSS REFERENCE

The inventive subject matter is a continuation of German Application No. DE 102011005611.4, filed Mar. 16, 2011 entitled “Turning Circle Reduction by Eliminating Ackermann Influence”, the entire disclosure of which is hereby incorporated by reference into the present disclosure and provides the basis for a claim of priority of invention under 35 U.S.C. §119.

### TECHNICAL FIELD

The disclosures made herein relate generally to a method and apparatus for steering the wheels of at least one vehicle axle of a motor vehicle, and more particularly, to steering the wheels of the axle having a double-pivot steering system.

### BACKGROUND

Motor vehicles are typically equipped with at least one steerable axle, the structure of which depends on the type of drive of the vehicle, (i.e., front-wheel, rear-wheel, or four-wheel), and on the type of wheel suspension, (i.e., independent, rear independent). Fundamentally, steering movements by the driver, or a steering demand by the driver, are transmitted to the wheels of the steerable axle by way of a steering wheel, a steering column, a steering gear, and a swivel mechanism consisting of a plurality of components connected to each other by joints, thereby controlling the wheels of the steerable axle and allowing them to pivot out relative to a straight-ahead travel position.

Vehicles with pivoted wheels are steered by either a single-pivot steering principle or a double-pivot steering principle. For single-pivot steering the steered wheels of an axle are turned by pivoting the entire axle about a pivot point at the level of the longitudinal axis of the vehicle. This type of steering is typically encountered on two-axle trailers and owing to the coaxial configuration of the steered vehicle axle, is a particularly simple design option for ensuring that at any angle of steering, the center point of all the circles traced by the wheels will lie at a common point, known as the Ackermann condition. Meeting the Ackermann condition avoids the need for the wheels to slip sideways when following a path around a curve. In the case of a vehicle with an unsteered rear axle and a front axle steered by the single-pivot principle, the single point is the point of intersection of the extension of the rear axle and the extension of the wheel axes of the front axle. Obviously, this means that all the wheels describe a circle around this point of intersection. The wear on the tires and the forces on the wheel suspension are correspondingly small.

However, single-pivot steering requires a very large amount of space to allow the entire steered axle to be pivoted relative to the longitudinal axis of the vehicle for large angles of lock. In other words, single-pivot steering systems have a very large turning radius. Moreover, the point of contact of the wheels with the underlying surface noticeably drifts toward the longitudinal axis of the vehicle as the angle of lock increases. This may result in a tendency for tilting. These severe disadvantages result in a single-pivot steering being used only in isolated cases on actively steered vehicles.

Double-pivot steering is a steering system for individual wheels. Double-pivot steering is not dependent upon pivoting of the entire steered axle and therefore takes up less installation space than single-pivot steering. Further, there is less of a tendency for tilting in the case of large angles of lock. In a double-pivot steering system each of the steerable vehicle axles is pivoted about its own steering pivot axes, and the pivot axes are arranged at wheel-facing ends of an axle running in the transverse direction of the vehicle between the wheels of the steerable axle. The steering pivot axes are formed by the lines connecting the steering points of the wheel suspension or by the longitudinal axes of steering knuckle pins, also known as kingpins.

If bath pivotable wheels of a vehicle axle having double-pivot steering are turned by the same amount, neither of the two wheels can roll on its natural path. Each wheel is forced into an unnatural path by the other wheel, and as a result, both wheels perform a noticeable sliding movement relative to the underlying surface in addition to the rolling movement, leading to undesirable wear on the wheels.

During the operation of a vehicle and especially during cornering, the wheels, in principle, should roll without the side slip movement encountered with single-pivot steering, which may be very stressful for the tires. In the case of double-pivot steering systems, this is achieved by virtue of the fact that the angle of lock provided for then wheel on the inside of the bend is greater than that for the wheel on the outside of the bend.

Referring again to the Ackermann principle, the extended center lines of the steering knuckles of the turned wheels must meet on the extended center line of a second, non-steerable vehicle axle to ensure operation of the vehicle with as little wear as possible, or without wear. The circular paths traversed by the wheels of the two vehicle axles then have a common center. As a result, the above-described side slip movements of the wheels are considerably reduced or avoided entirely.

If the rays, or extensions, of center lines of the steering knuckles of the wheels do not meet at a single point, a deviation from the optimum steering angle has occurred. This is typically known as track angle error or steering angle error. The larger the steering angle error, the more stress is placed on the tires in general.

Ackermann geometry represents the ideal ratio between the angle of steering lock of the wheel on the inside of the bend and the angle of steering lock of the wheel on the outside of the bend. The Ackermann geometry means that the optimum angle of steering lock of the wheel on the outside of the bend is relatively small in relation to the angle of steering lock of the wheel on the inside bend. Owing to the principles used for the steering mechanism in practice, there is generally a deviation from the optimum angle of steering lock of the wheels. These deviations from the optimum steering angle result in undesirably high tire wear during cornering. Moreover, stresses arise in the driver train, requiring larger dimensioning of the drive train components, thereby disadvantageously increasing both the operating costs and the production costs of a vehicle.

By nature, the maximum angle of steering lock of the wheels of the steerable axle determines the smallest possible optimum turning circle of the vehicle. A turning circle which is as small as possible gives the vehicle good maneuverability and is generally desirable. However, the optimum turning circle of the vehicle is greatly influenced by the Ackermann geometry.

Therefore, although low-wear cornering for the tires is possible if the Ackermann geometry (i.e., the optimum angle of steering lock of the wheel on the outside of the bend in relation to the angle of steering lock of the wheel on the inside of the bend) is maintained, an optimum turning circle with as small a diameter as possible cannot be achieved. This is because the maximum possible angle of steering lock of the wheel on the outside of the bend cannot be used due to the fact that the wheel on the inside of the bend is already against a steering angle end stop. Consequently, the maneuverability of the vehicle when the Ackermann geometry is maintained is reduced, despite the possibility of a larger angle of steering lock of the wheel on the outside of the bend.

On the other hand, a deviation from the optimum angle of steering lock of the wheels, such as that which is widely encountered in practice, leads to an interaction between the pivoted wheels of the steerable axle with the wheels each defining different turning circles.

There is a need for steering the wheels of at least one vehicle axle using a double-pivot steering system, which gives the vehicle a high degree of maneuverability and as little tire stress as possible without the need to modify pivotal connection points of a steering mechanism and without the need to modify steering knuckle pivot points, tie rod length, or steering arm length as compared to a conventional steering mechanism.

### SUMMARY

The inventive subject matter is a method and apparatus for steering the wheels of at least one axle of a vehicle having a double-pivot steering system. Each wheel of the steerable axle has a load adjusting device that adjusts a contact force of an associated wheel to the contact force of the other wheels of the vehicle axle. The wheels are steerable in a manner such that the wheel on the outside of the bend adopts a larger angle of steering lock relative to the wheel on the inside of the bend than that specified by Ackermann geometry. The turning circle of the vehicle is obtained from the mutual influence or interaction between a wheel on the inside of the bend and a wheel on the outside of the bend.

The inventive subject matter is an apparatus for steering the wheels of at least one axle of a vehicle, the axle being steerable by means of a double-pivot steering system using a wheel load adjusting device associated with each wheel of the steerable axle. A contact force of an underlying surface of an associated wheel is adjusted during cornering relative to a contact force of other wheels of the vehicle axle. Further, the wheels are steerable in such a way that the wheel on an outside bend has a larger angle of steering lock, relative to the wheel on an inside of the bend, than that specified by the Ackermann condition (i.e., the optimum angle of steering lock which meets the Ackermann condition).

A deviation of the angle of steering lock of the wheel on an outside bend from the Ackermann angle is called a steering angle deviation and, in contrast to a steering angle error, represents a desired deviation from the Ackermann angle.

It is an advantage of the inventive subject matter that the contact force of the wheel on the inside bend can be reduced and the contact force of the wheel on the outside bend can be, increased. Therefore, only the wheel on the outside of the bend is subjected to a load, during cornering, leading to a reduction in the mutual influence of the pivoted wheels of the vehicle axle.

Another advantage of the inventive subject matter is that the contact force can be adjusted in accordance with a vehicle speed. According to the inventive subject matter, the contact force is adjustable only at low driving speed. This feature avoids the possibility of an adverse effect on the directional stability of the vehicle at high vehicle speeds. At low driving speeds, especially when cornering at the maximum, or near the maximum, angle of lock, where the maneuverability of the vehicle is particularly important and the speed of the vehicle is normally low, the inventive subject matter enables the wheel load adjusting device to adjust the contact force of the steered wheels.

It is another advantage of the inventive subject matter that the wheel load adjusting device is an active stabilizer. The active stabilizer has a twisting actuator. Shaft ends of two stabilizer halves may be twisted relative to one another in order to achieve roll stabilization of the vehicle. The inventive subject matter imposes a load on a wheel of a vehicle axle relative to another wheel on the same axle by twisting the stabilizer halves in opposite directions. In the alternative, the function of an active stabilizer may be implemented using an active roll control device, a level control device, or a device for adjusting a spring constant of the system.

The inventive subject matter adjusts a contact force of a wheel associated with a wheel load adjusting device, during cornering, such that the influence of the Ackermann geometry, or the mutual influence of the pivoted wheels on the outside and on the inside of the bend is reduced or suppressed, despite the deviation chosen in the steering angle of the wheel on the outside bend of the Ackermann angle. The result is low tire stress, low tire wear and low stressed in the drive train during cornering of the vehicle.

### DESCRIPTION OF DRAWINGS

FIG. 1 is a block diagram of the inventive subject matter.

Elements and steps in the figures are illustrated for simplicity and clarity and have not necessarily been rendered according to any particular sequence. For example, steps that may be performed concurrently or in different order are illustrated in the figures to help to improve understanding of embodiments of the inventive subject matter.

### DESCRIPTION OF INVENTION

While various aspects of the inventive subject matter are described with reference to a particular illustrative embodiment, the invention is not limited to such embodiments, and additional modifications, applications, and embodiments may be implemented without departing from the inventive subject matter. In the figures, like reference numbers will be used to illustrate the same components. Those skilled in the art will recognize that the various components set forth herein may be altered without varying from the scope of the inventive subject matter.

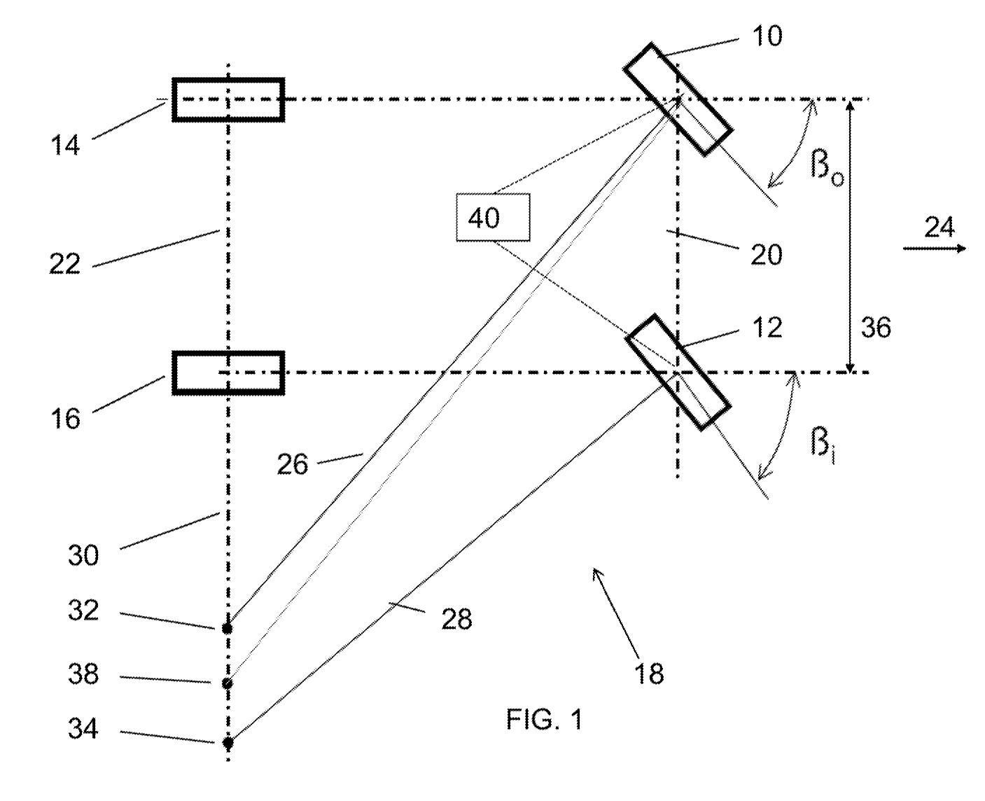

FIG. 1 is a plan view of four wheels 10, 12, 14, and 16 on the underside of a vehicle 18. Also shown is the geometric relationship between a maximum angle of steering lock, β, and a turning circle 34 of the vehicle 18. βₒ and βᵢ represent maximum steering lock angles of pivotable wheel 10 and pivotable wheel 12 of a front axle 20 of the vehicle 18 respectively. The wheels 10, 12 are steerable by means of a double-pivot steering system. The rear wheels 14 and 16 are shown as attached to an unsteered rear axle 22 of the vehicle 18. Wheels 10 and 14 are on the outside of a bend and wheels 12 and 16 are on the inside of the bend. In FIG. 1 a forward direction of travel for the vehicle 18 is indicated by an arrow 24.

Lines 26, 28 and 30 shown in FIG. 1 are perpendicular to a center of each wheel 10, 12 and rear wheels 14 and 16. These lines represent extensions of the wheel axes of each corresponding wheel. In FIG. 1, the wheel axes of the rear wheels 14, 16 coincide with the rear axle 22 of the vehicle 18. Lines 26 and 28 intersect line 30 at points of intersection 32 and 34 respectively. These points of intersection 32, 34 are the turning circle centers of the vehicle 18, which are associated with corresponding wheels 10 and 12 respectively.

Two different points of intersection 32, 34 are obtained with respect to the position on line 30. The position of the points of intersection 32, 34 on line 30 depends on the angle of steering lock, β, of the respective wheel 10, 12 and the distance between the wheels 10, 12, known as track width 36.

The different points of intersection 32, 34 give a resultant (mean) turning circle center shown at a point of intersection 38. As may be seen in FIG. 1, the resultant turning circle center 38 is farther away from the vehicle than the turning circle center 32 of the wheel 10 on the outside bend. Consequently, the resultant turning circle of the vehicle is also larger than that of the wheel 10 on the outside bend. As a result, the kinematic limitations, i.e. steering angle error, and/or the limited amount of installation space available in the region of the wheel suspensions, i.e. maximum possible angle of steering lock of the wheels, prevents optimum, i.e. smallest, vehicle turning circle.

Turning circle of the vehicle is defined as:

$$Turning Circle = d + w \cdot \sqrt{{( \frac{1}{tan {β}_{o}} + \frac{1}{tan {β}_{i}} + \frac{t}{w} )}^{2} + 4}$$

where d is a tire width, w is a wheelbase, t is the track width 36.

The inventive subject matter provides a method and apparatus for steering the wheels 10, 12 of the vehicle axle 20 using a double-pivot, steering system. The actual position of the resultant turning circle center 38 and hence the turning circle of the vehicle is obtained from the mutual influence or interaction between wheel 10 on the outside of the bend and wheel 12 on the inside of the bend. A load adjusting device 40 is associated with each wheel 10, 12 of the steerable axle 20. The wheel load adjusting device 40 adjusts, or modifies, a contact force on an underlying surface of an associated wheel 10, 12 during cornering of the vehicle 18 relative to a contact force of the other wheels of the vehicle axle. The wheels 10, 12 are steerable in such a way that the wheel 10 on the outside of the bend adopts a larger angle of steering lock βₒ relative to the wheel 12 on the inside bend. The angle of steering lock βₒ on the outside wheel is also larger than that specified by the Ackermann condition. The angle of steering lock βₒ of the wheel 10 on the outside of the bend deviates from the Ackermann angle. This angle, is a steering angle deviation (not to be confused with a steering angle error) and represents a desired deviation from the Ackermann angle.

The wheel load adjusting device 40, which encompasses a data processing device, ensures that the contact force of the wheel associated with the wheel load adjusting device is adjustable during cornering. The contact force may be increased or decreased relative to the contact force of the other wheels on the same axle 20. As a result, the effect of the Ackermann geometry or the mutual influence of the wheels during cornering caused by the steering angle deviation of the pivoted wheels may be reduced or completely suppressed. Despite the steering angel deviation of the pivoted wheels, there is low tire stress, low tire wear and low stressed in the drive train while the vehicle is cornering.

According to the inventive subject matter, a steering angle deviation is chosen so that the wheel on the outside of the bend adopts a larger angle of steering lock, in comparison with the wheel on the inside of the bend, than a steering angle necessary to meet the Ackermann condition. The possible angle of steering lock of the wheel on the outside of the bend is significantly increased since it is no longer limited by the generally significantly larger angle of steering lock of the wheel on the inside of the bend. The possible angle of steering lock of the wheel on the outside of the bend is also no longer limited by a premature steering angle end stop abutment of the wheel on the inside of the bend when the Ackermann condition is satisfied. This gives the vehicle better overall maneuverability. The angle of steering lock of the wheel on the outside of the bend is now limited only by the pivoting or installation space within which the wheel can pivot freely. This is determined by the wheel suspension and the vehicle body design.

The load adjusting mechanism allows for the contact force of the wheel on the inside of the bend to be modified, i.e., reduced and/or the contact force of the wheel on the outside bend to be modified, i.e., increased. The effect is that approximately only the wheel of the steerable vehicle axle that is on the outside of the bend is subjected to a load during cornering, leading to a reduction in the mutual influence of the pivoted wheels of the vehicle axle.

A relief load on wheel 23 on the inside of the bend leads to a reduction in the influence of the wheel 12 on the inside of the bend on the resultant turning circle center about which the vehicle turns and consequently to a displacement of the turning circle center toward the turning circle center of the wheel on the outside of the bend. The wheel 10 on the outside of the bend and the rear wheels 14, 16 continue to be subjected to a load. As a result, the turning circle of the vehicle becomes smaller owing to the relief of the load on the wheel 12 on the inside of the bend and to the steering angle deviation, envisaged according to the inventive subject matter, of the wheel 10 on the outside of the bend toward a larger angle of steering lock than that required by the Ackermann condition.

In another embodiment of the inventive subject matter, the contact force may be adjusted in accordance with a vehicle speed. The contact force adjustable only at a predetermined low driving speed to avoid the possibility of a disadvantageous effect on the directional stability of the vehicle at high vehicle speed. When cornering a vehicle at a maximum or near a maximum angle of lock, the maneuverability of the vehicle is important and the speed of the vehicle is normally low. When a vehicle is cornering at or below, a predetermined vehicle speed, that is typically a low speed, the inventive subject matter enables the wheel load adjusting device to adjust the contact force of the steered wheels as described above in order to give the vehicle the best possible maneuverability with a minimum turning circle.

In another embodiment of the inventive subject matter, the wheel load adjuster device 40 is an active stabilizer. An active stabilizer has a twisting actuator. Shaft ends of two stabilizer halves may be twisted relative to one another in order to achieve roll stabilization of the vehicle. A load is imposed on a wheel of a vehicle axle relative to the other wheel of the same vehicle axle according to the inventive subject matter by twisting the stabilizer halves in opposite directions. Many vehicles are equipped with an active stabilizer. In the alternative, the wheel load adjuster device may be performed by any active roll control device of the vehicle that enables the wheel load to be adjusted in accordance with the inventive subject matter.

In yet another embodiment of the inventive subject matter the wheel load adjusting device may be a level control device of the associated wheel. With a level control device it is possible to vary the height of the corresponding wheel relative to the underlying surface, i.e., the height of the wheel relative to the height of the other wheel of the vehicle. This change in height deliberately varies the contact force of the wheel on the underlying surface in order to enable the vehicle to corner with little wear on the tires and with a minimum possible turning circle in accordance with the inventive subject matter.

In still another embodiment of the inventive subject matter, the wheel load adjusting device is a device for adjusting a spring constant of the spring system of the associated wheel. In general, the spring constant or spring characteristic describes the dependence of the spring force on the spring travel. The relationship between the spring force and the spring travel may be varied during the operation of the vehicle in such a way that relief or imposition of a load on the pivoted wheel, and hence variation of the contact force of the wheel on the underlying surface, is possible in order to enable the vehicle to corner while sparing the tires and with a minimum possible turning circle in accordance with the inventive subject matter.

A method of the inventive subject matter for steering the wheels of at least one vehicle axle of a vehicle, the axle being steerable by means of a double-pivot steering system, having a wheel load adjusting device associated with each wheel of the steerable axle describes steering the wheels in such a way that the wheel on the outside bend of the bend adopts a steering angle lock that is larger than the wheel on the inside of the bend, and at the same time is larger than an angle specified by the Ackermann condition so that the contact force of the associated wheel on an underlying surface may be adjusted during cornering relative to the contact force of the other wheels of the vehicle axle by means of the wheel load adjusting device.

Adjusting the contact force of the wheel associated with the wheel load adjusting device during cornering significantly reduces, or even suppresses, the influence of the Ackermann geometry or the mutual influence of the pivoted wheels on the outside and the inside of the bend. The steering angle deviation is chosen in the steering angle of the wheel on the outside of the bend from the Ackermann angle. The steering angle deviation is chosen so that the wheel on the outside of the bend adopts a larger angle of steering lock in comparison with the wheel on the inside of the bend. The steering angle deviation is larger than necessary to meet the Ackermann condition. The possible angle of steering lock of the wheel on the outside of the bend is increased since it is no longer limited by the larger angle of steering lock of the wheel on the inside of the bend. The possible angle of steering lock on the outside of the bend is not limited by the premature steering angle end stop abutment of the wheel on the inside of the bend when the Ackermann condition is satisfied. The result is better vehicle maneuverability. The angel of steering lock of the wheel on the outside of the bend is limited only by the pivoting or installation space provided by the wheel suspension or the body.

The contact force may be adjusted so that the wheel on the inside of the bend is reduced, the contact force of the wheel on the outside of the bend may be increased, or the contact force of the wheel on the inside of the bend is reduced and the contact force of the wheel on the outside of the bend is increased. The effect is that only the wheel of the steerable axle which is on the outside of the bend is subjected to a load during cornering, leading to a reduction in the mutual influence of the pivoted wheels of the vehicle axle.

Referring to FIG. 1, a relief of the load on the wheel 12 on the inside of the bend, means that the wheel 10 on the outside of the bend and the rear wheels 14, 16 continue to be subjected to a load. The influence the wheel 12 on the inside of the bend has on the resultant turning circle center 38 about which the vehicle turns. Consequently, the turning circle center 32 of the inside wheel 12 is displaced toward the turning circle center 32 of the wheel on the outside of the bend. Ultimately, the turning circle 38 of the vehicle becomes smaller.

The step of adjusting the contact force may be accomplished using a vehicle speed. The contact force is adjusted only at a predetermined, low, driving speed. The directional stability of the vehicle at high speeds may be adversely affected. At a low driving speed, especially when cornering at or near a maximum angle of lock, the maneuverability of the vehicle is particularly important and the speed of the vehicle is typically low. It is at low speed, when cornering, that the contact force of the pivoted wheels is adjusted by means of the wheel load adjusting device in order to give the vehicle the best possible maneuverability with a minimum turning circle 38.

It is understood from the disclosure made herein that methods, processes and/or operations adapted for carrying out wheel load adjustment as disclosed herein are tangibly embodied by non-transitory computer readable medium having instructions thereon that are configured for carrying out such functionality. The instructions may be accessible by one or more data processing devices from a memory apparatus (e.g. RAM, ROM, virtual memory, hard drive memory, etc.), from an apparatus readable by a drive unit of a data processing system (e.g., a diskette, compact disk, a tape cartridge, etc.) or both. Accordingly, embodiments of computer readable medium in accordance with the inventive subject matter include a compact disk, a hard drive, RAM, or other type of storage apparatus that has imaged thereon a computer program (e.g., instructions) configured for carrying out the inventive subject matter. A control module of an electronic control system configured for providing wheel load adjustment commands and may include various signal interfaces for receiving and outputting signals. The control module may be any control module of an electronic control system that provides for wheel load adjustment capability. Such control functionality may be implemented with a standalone control module or with two or more separate but interconnected control modules. In another example, wheel load adjustment capability may be implemented in a distributed manner whereby a plurality of control units, control modules, computers, or the like (e.g., an electronic control system) jointly carry out operations providing such wheel load adjustment capability.

In the foregoing specification, the invention has been described with reference to specific exemplary embodiments. Various modifications and changes may be made, however, without departing from the scope of the inventive subject matter as set forth in the claims. The specification and figures are illustrative, rather than restrictive, and modifications are intended to be included within the scope of the inventive subject matter. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

The terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the inventive subject matter, in addition to those not specifically recited, may be varied or otherwise particularly adapted to specific environments, manufacturing specifications, design parameters or other operating requirements without departing from the general principles of the same.

1. An apparatus for steering wheels of at least one vehicle axle with a double-pivot steering system, comprising:
a load adjusting device associated with the wheels; and
a contact force of a wheel on the vehicle axle being modified during cornering by the load adjusting device to adopt an angle of steering lock for a wheel on an outside bend that is larger than an angle of steering lock for a wheel on an inside bend.

2. The apparatus as claimed in claim 1 wherein the angle of steering lock of the wheel on the outside bend is larger than an angle specified by an Ackermann condition.

3. The apparatus as claimed in claim 1 further comprising:
the contact force of the wheel on the outside of the bend being increased during cornering; and
a contact force of the wheel on the inside of the bend being decreased during cornering.

4. The apparatus as claimed in claim 1 wherein the contact force is adjusted when cornering at or below a predetermined vehicle speed.

5. The apparatus as claimed in claim 1 wherein the load adjusting device is an active stabilizer.

6. The apparatus as claimed in claim 1 wherein the load adjusting device is a level control device.

7. The apparatus as claimed in claim 1 wherein the load adjusting device is a device for adjusting a spring constant of a wheel.

8. A method for controlling a contact force of at least one wheel of at least one vehicle axle steerable using a double-pivot steering system, comprising:
a load adjusting device modifying a contact force of the at least one wheel relative to other wheels during cornering to adopt a steering lock angle for a wheel on an outside bend that is larger than a steering lock angle for a wheel on an inside bend.

9. The method as claimed in claim 8 wherein the step of modifying a contact force of the at least one wheel further comprises modifying the contact force of the at least one wheel to adopt a steering lock angle that is larger than an angle defined by an Ackermann condition.

10. The method as claimed in claim 8 wherein the step of modifying a contact force further comprises:
reducing a contact force of a wheel on the outside bend; and
increasing a contact force of a wheel on the inside bend.

11. The method as claimed in claim 8 wherein the step of modifying a contact force further comprises modifying the contact force when the vehicle is cornering at or below a predetermined vehicle speed.

12. The method as claimed in claim 8 wherein the load adjusting device is an active stabilizer and the step of modifying a contact force further comprises adjusting the active stabilizer to modify the contact force of the at least one wheel.

13. The method as claimed in claim 8 wherein the load adjusting device is a level control device and the step of modifying a contact force further comprises adjusting the level control device associated with the at least one wheel.

14. The method as claimed in claim 8 wherein the load adjusting device is a spring system and the step of modifying a contact force further comprises adjusting a spring constant of the spring system associated with the at least one wheel.

15. A double-pivot steering system of a vehicle comprising:
at least one vehicle axle having a wheel on an outside bend and a wheel on an inside bend;
a load adjusting device associated with the wheels of the at least one vehicle axle; and
a contact force of a wheel being modified during cornering by the load adjusting device to adopt an angle of steering lock associated with a wheel on the outside bend that is larger than an angle of steering lock associated with the wheel on the inside bend.

16. The system as claimed in claim 15 wherein the angle of steering lock of the wheel on the outside bend is larger than an angle specified by an Ackermann condition.

17. The system as claimed in claim 15 further comprising:
the contact force of the wheel on the outside of the bend being increased; and
a contact force of the wheel on the inside of the bend being decreased.

18. The system as claimed in claim 15 wherein the contact force is adjusted when cornering at or below a predetermined vehicle speed.

19. The system as claimed in claim 15 wherein the load adjusting device is an active stabilizer.

20. The system as claimed in claim 15 wherein the load adjusting device is a level control device.

21. The system as claimed in claim 15 wherein the load adjusting device is a device for adjusting a spring constant of a wheel.
